(19) United States
(12) Patent Application Publication
(10) Pub. No.: US 2002/0065710 A1
(43) Pub. Date: May 30, 2002

(54) Server with help function, control method for server and system having server, storage medium storing program realizing such method

(76) Inventor: Rie Saito, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/988,447

(22) Filed: Nov. 20, 2001

(30) Foreign Application Priority Data
Nov. 24, 2000 (JP) 358059/2000
Oct. 26, 2001 (JP) 329513/2001

(51) Int. Cl. G06F 17/60

(52) U.S. Cl. 705/10

(57) ABSTRACT

A help server selects helper terminals each for providing an answer to an inquiry by a user, in accordance with the contents of an answer, a desired communication ability and a desired fee respectively on the side of each helper terminal and the contents of an inquiry, a communication ability and a desired fee respectively on the side of the user at the user terminal, and notifies the user of the selected helper terminals. The user selects a desired helper terminal from the notified helper terminals to obtain an answer. The help server can return the answer to the user inquiry at the fee and answer contents desired by the user.

### BACKGROUND OF THE INVENTION

1. Field of the Invention

The present invention relates to a server having a function of supporting a user, to a control method for a server and a system having a server, and to a storage medium storing a program realizing such a method.

2. Related Background Art

Recent information processing apparatuses such as personal computers and portable information terminals are becoming more compact, lightweight and inexpensive and many persons can have such apparatuses easily. Developments of the Internet are remarkable and any information can be searched easily via the Internet.

In such a case, a search engine is generally used to search desired information. However, if proper keywords for narrowing down the information to be searched are not set, the search engine extracts only unnecessary information. In addition, it often takes a long time to browse all extracted pages, so that accurate information cannot be obtained at once.

In order to obtain more accurate information speedily, some persons use information research services to ask a person having expert knowledge about the information. A personal computer of a user asking a question can be connected nowadays to a personal computer of a helper returning an answer via a network such as the Internet and a telephone line.

Some helpers wish to widely distribute their knowledge free of cost, whereas some helpers do not make information in public if a fee in compensation for it is not paid. Some users wish to obtain information only free of cost, whereas some users wish to obtain information even if a high fee is requested.

Technical innovation of information processing apparatuses is now remarkable, and there are various types of information processing apparatuses and various connection methods to networks. In such circumstances, there are many communication methods such as a speech fixed telephone, an Internet telephone, a TV telephone, a portable telephone, a portable TV telephone, an e-mail, and a bulletin board or chat via the Internet. Computers of users and helpers have various types of communication abilities.

A user is required to randomly select a proper helper from various types of helpers, and cannot select a helper efficiently. It is therefore difficult to obtain information in a manner the user desires.

### SUMMARY OF THE INVENTION

According to one embodiment of the invention, an object of the invention is to provide a help system capable of efficiently returning information desired by a user to a user terminal in a manner the user desires.

Other objects and features of the present invention will become apparent from the following description taken in conjunction with the accompanying drawings.

### BRIEF DESCRIPTION OF THE DRAWINGS

FIG. 1 is a diagram showing the structure of a help server.

FIG. 2 is a diagram showing an example of a helper management table.

FIG. 3 is a sequence chart illustrating the operation of a help system.

FIG. 4 is a diagram showing a helper list.

FIG. 5 is a flow chart illustrating the operation of the help server.

FIG. 6 is a flow chart illustrating the operation to be executed at a user terminal.

FIG. 7 is a flow chart illustrating the operation to be executed at a helper terminal.

FIG. 8 is a diagram showing the overall structure of the help system.

FIG. 9 is a diagram showing an example of the structure of the help server.

FIG. 10 is a diagram showing an example of a processing inquiry table.

### DETAILED DESCRIPTION OF THE PREFERRED EMBODIMENTS

Embodiments of the invention will be described with reference to the accompanying drawings.

(Overall Structure of Help System)

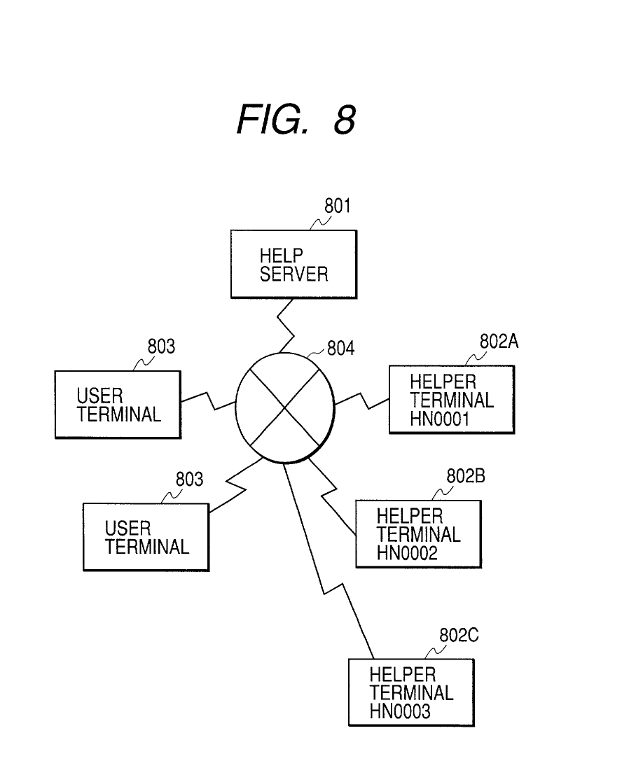

In the overall structure of a help system of this embodiment, as shown in FIG. 8, a help server 801, a plurality of helper terminals 802 and a plurality of user terminals 803 are interconnected via a network 804 such as the Internet, an intranet, and a public telephone network. Although only one help server 801 is shown for the purposes of convenience, a plurality of help servers may be used.

The help terminal 802 may be an information processing apparatus such as a personal computer (PC) and a portable information terminal, or a communication apparatus, respectively installed in a home or satellite office at which a helper works. The user terminal 803 may be an information processing apparatus such as a PC and a portable information terminal, or a communication apparatus, respectively installed in a home or office of a user.

(Structure of Help Server)

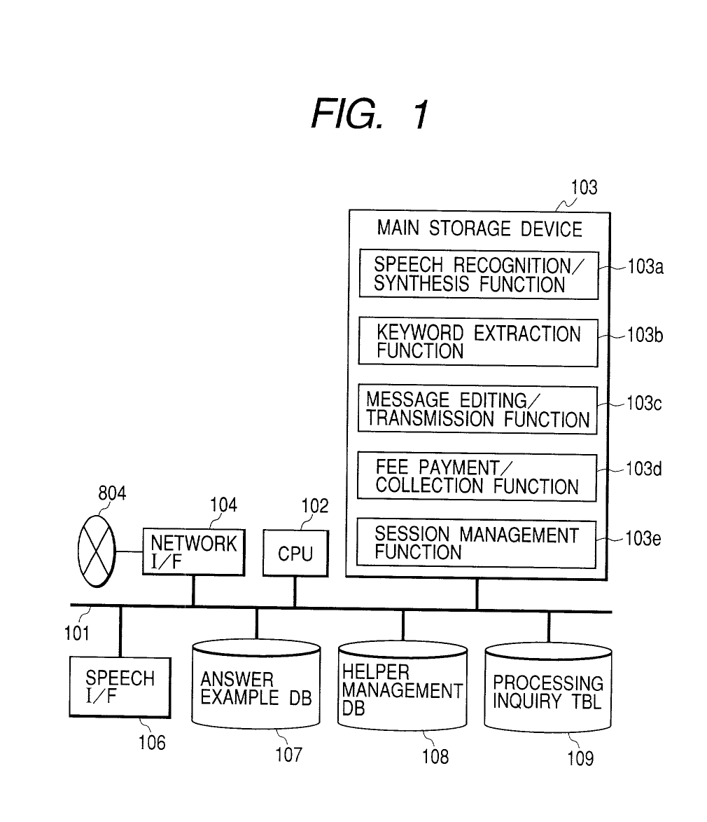

FIG. 1 shows an example of the structure of the help server 801 in the help system of this embodiment.

The help server 801 of this embodiment is constituted of a central processing unit (hereinafter called a CPU) 102, a main storage device 103 for storing a program for controlling CPU 102, a network interface 104 for connection to a network 804, a speech interface 106, an external memory 107 for storing an answer example database, an external memory 108 for storing a helper management database, an external memory 109 for storing a processing inquiry table, and the like, respectively connected to a system bus 101.

The functions stored in the main storage device 103 include, for example, a speech recognition/synthesis function 103a, a keyword extraction function 103b, a message editing/transmission function 103c, a fee payment/collection function 103d, a session management function 103e, and the like. CPU 102 is controlled by using these functions.

The network interface 104 performs an interface control such as a communication protocol control for a connection to the network 804. Although one network 804 is shown for the purposes of convenience, it is assumed that the network interface 104 supports a plurality of communication protocols and protocol conversion functions.

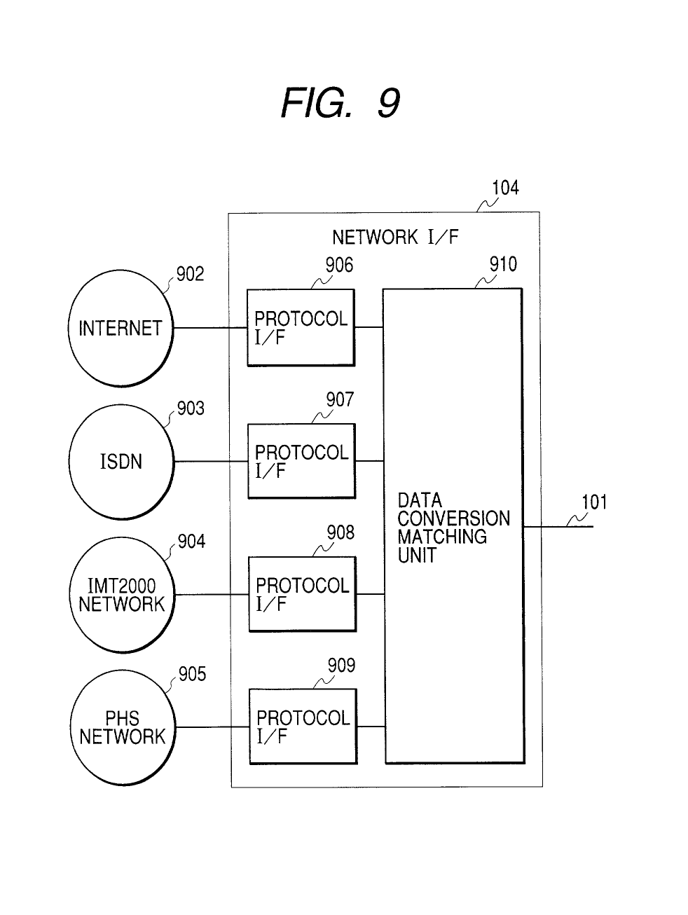

As shown in FIG. 9, the network interface 104 has a plurality of protocol interfaces 906 to 909 for connections to networks such as the Internet 902, an ISDN (Integrated Service Digital Network) 903, an IMT 2000 (International Mobile Telecommunications 2000) network 904 and a PHS (Personal Handy-phone System) network 905. Each protocol interface is connected to the system bus 101 via a data conversion matching unit 910 for converting each data format into a common format for format matching.

In FIG. 9, although specific communication protocols for the help system are shown for the purposes of convenience, the embodiment is not limited only thereto.

The speech interface 106 recognizes voices of a user input from a telephone (Internet telephone, fixed telephone, portable telephone) or the like connected via the network interface 104 and converts the voices into digital data, or synthesizes digital data supplied from CPU 102 controlled by the contents of the main storage device 103.

Although the speech interface 106 and network interface 104 are shown separately in FIG. 1, the speech interface 106 may be included in the network interface 104.

The answer example database 107 stores information such as answers of the helper terminals 802 in response to past inquiries of the user terminals 803, and when necessary the answer example database 107 is referred to by a program controlled by the contents of the main storage device 103.

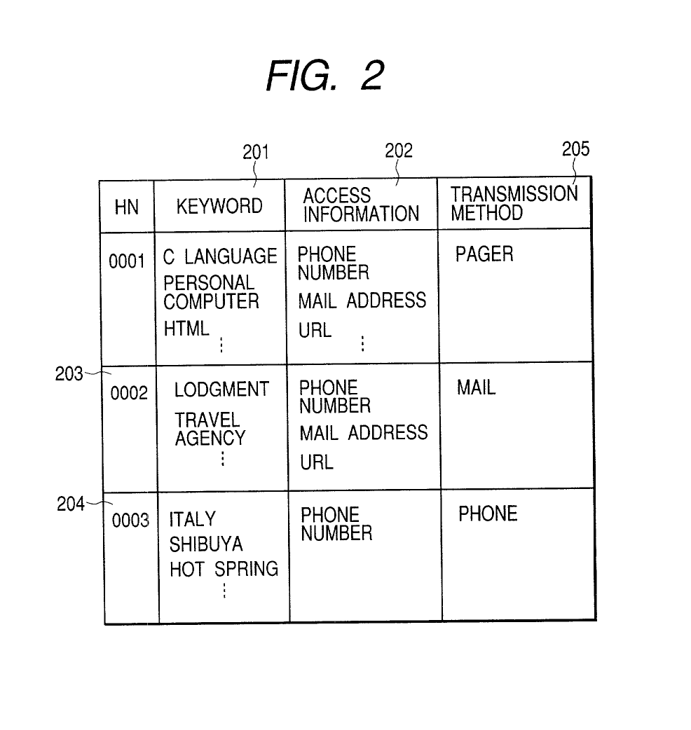

As shown in FIG. 2, the helper management database 108 stores, for example, keywords 201 which the helper terminals 802 can cover, access information 202 such as telephone numbers and mail addresses for accessing the helper terminals 802 from the help server 801, and transmission methods 205 including the communication abilities of the helper terminals 802.

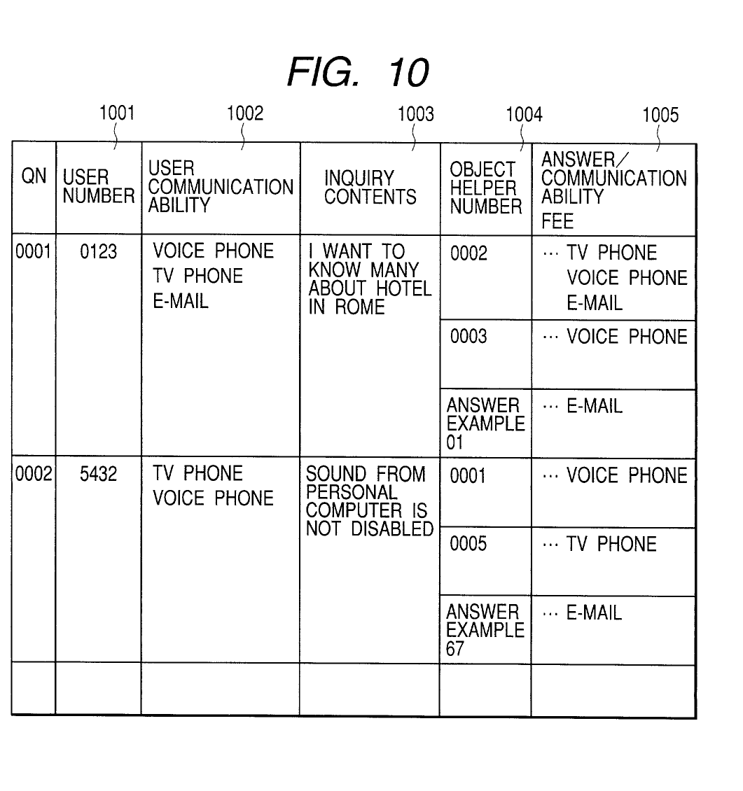

As shown in FIG. 10, the processing inquiry table 109 stores, for example, ID's (telephone numbers or the like) 1001 of users making inquiries under current processing, inquiry contents and keywords 1003, helper numbers 1004 of the helper terminals 802 searched from a helper management file in the helper management database 108 (FIG. 2) as search candidates, and information 1005 including answers/desired fees/desired communication abilities supplied from the helper terminals, respectively for each of the helper terminals 802.

(Operation of Help System)

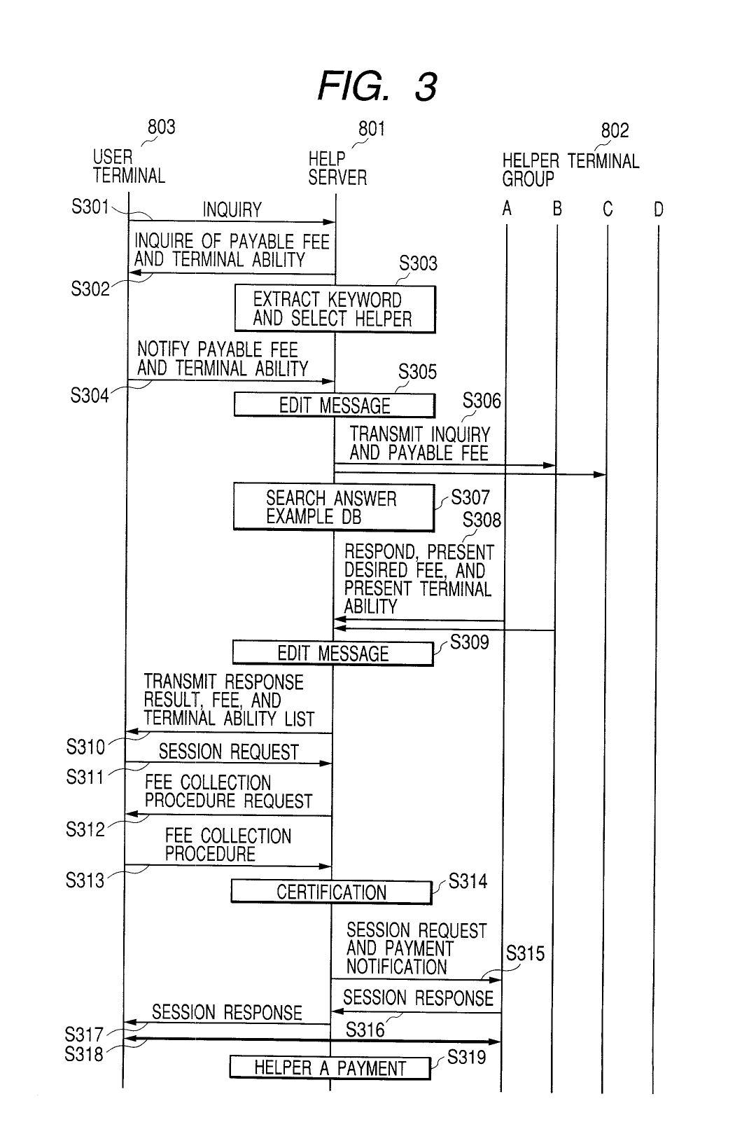

Next, with reference to the sequence chart shown in FIG. 3, the operation of the help system of this embodiment will be described.

First, at Step S301 an inquiry, e.g., “Want to know various information on lodging houses in Rome”, is sent from the user terminal 803 to the help server 801. As the inquiry methods from the user terminal 803 to the help server 801, a speech telephone, an e-mail, a message transmission on the Web via the network 804 and the like may be used.

If an inquiry is made through a speech telephone, the speech interface 106 in FIG. 1 of the help server 801 and a program of the speech recognition/synthesis function 103a in FIG. 1 stored in the main storage device 103 in FIG. 1 recognize user voices and convert the voices into digital data.

In making an inquiry from a user, the user may input (pronounce) only the keywords (e.g., “Rome” and “Lodging house”) of the inquiry contents into (toward) the user terminal 803 to transmit them to the help server 801. The user may input (pronounce) a long sentence (“Want to know various information on lodging houses in Rome”) of the inquiry contents into (toward) the user terminal 803 to transmit them to the help server 801 which in turn extracts keywords from the sentence by using the keyword extraction function 103b in FIG. 1.

The help server 801 received the inquiry from the user terminal 803 forms a new field in the processing inquiry table 109 in FIG. 1 and stores therein the user number 1001 in FIG. 10 and the inquiry contents 1003 in FIG. 10.

Next, at Step S302 the help server 801 issues an inquiry to the user terminal 803 as to a payable fee (e.g., an approximate maximum fee payable to the information) and communication abilities of the user terminal 803 (data transfer speed, information transfer ability, terminal type and the like). In the case of a speech telephone, a program of the speech recognition/synthesis function 103a in FIG. 1 stored in the main storage device 103 of the help server 801 and the speech interface 106 in FIG. 1 synthesize digital data into a speech and reproduce it to make an inquiry.

In addition to the above operation, at Step S303 the help server 801 extracts keywords from the inquiry contents of the user by using the keyword extraction function 103b in FIG. 1, and searches the helper terminal 802 hitting the extracted keywords, from the helper management table (FIG. 2) stored in the helper management database 108. In the example of this embodiment, the keywords of “Rome” (including “Italy”), “lodging”, “lodging house” (including “travel”) and the like are extracted from the sentence “Want to know various information on lodging houses in Rome”.

By referring to the helper management table (FIG. 2), a helper terminal 802C having a helper number 204 HN0003 and hitting the keyword “Italy” and a helper terminal 802B having a helper number 203 HN0002 and hitting the keyword “lodging” are selected.

At Step S304 the payable fee and communication abilities are notified from the user terminal 803.

For example, it is assumed that the user terminal 803 notifies the information such as “up to about 500 Yen” as the payable fee and “speech/TV telephone terminal/e-mail” as the communication abilities. In notifying the communication abilities, the higher priority order is preferably used as the order of communication abilities. A communication ability order preset at the user terminal 803 may be notified, or a communication ability order desired to be used by the user for the response to the inquiry and manually set by the user may be notified each time.

The inquiry for the payable fee and communication abilities at Step S302 and the notice at Step S304 may be performed at the inquiry at Step S301 and omitted. However, as in this embodiment, the user is made to notify the payable fee at Step S304 different from the inquiry at Step S301 so that it is possible to make the user confirm again the will of the inquiry.

Upon reception of the notice of the payable fee and communication abilities from the user terminal 803, the help server 801 stores the communication abilities of the user terminal 803 notified at Step S304 in the user communication ability field 1002 in FIG. 10 in the corresponding inquiry field of the processing inquiry table 109 shown in FIG. 1.

Next, at Step S305 the help server 801 forms an inquiry message to be transmitted to the helper terminals, by using the massage editing/transmission function 103c, and then at Step S306 transmits the inquiry message to the helper terminal 802C HN0003 and helper terminal 802B HN0002 selected at Step S303.

The message created at Step S305 does not contain information on the user terminal 803 and information capable of identifying the user in order to protect the privacy of the user, although the message contains the information on the user inquiry contents, communication abilities of the user terminal 803 and the payable fee.

The method of transmitting the message at Step S306 may be group transmission or group mailing, or if the helper terminals 802 are wireless terminals or the like, the message may be entered in the extended data field of group notice information and transmitted to the helper terminals 802.

In the case of a speech telephone, a program of the speech recognition/synthesis function 103a in FIG. 1 stored in the main storage device 103 of the help server 801 and the speech interface 106 in FIG. 1 synthesize digital data into a speech and reproduce it.

The method of transmitting the message at Step S306 may be designated for each helper terminal 802 and registered in the helper management table (FIG. 2).

The helper number of each helper terminal 802 to which the help server 801 transmitted the message is stored in the corresponding inquiry field 1004 in FIG. 10 of the processing inquiry table 109 in FIG. 1.

The help server 801 compares the user communication abilities stored in the user communication ability field 1002 in FIG. 10 of the processing inquiry table 109 in FIG. 1 with the communication abilities of each helper terminal 802 stored in the communication method field 205 in FIG. 2 of the helper management database 108 in FIG. 1, and does not transmit the message to those helper terminals 802 not having the communication abilities notified by the user terminal 803.

At Step S307 the help server 801 searches the answer history of the past inquiry similar to the present inquiry from the answer example database 107 in FIG. 1, and stores it in the answer example number field 1004 in FIG. 10 in the corresponding inquiry field of the processing inquiry table 109 in FIG. 1.

At Step S308 the help server 801 receives responses and messages of desired fees and desired communication abilities from the helper terminals 802B and 802C. By referring to the contents of the messages and the past answer examples stored in the processing inquiry table 109 in FIG. 1, the help server 801 creates a helper list at Step S309 and transmits it to the user terminal 803 at Step S310.

In notifying the communication abilities at Step S308 from the helper terminal 802, the higher priority order is preferably used as the order of communication abilities. A communication ability order preset at the helper terminal 802 for the response to the inquiry and desired to be used by the helper terminal may be notified, or a communication ability order manually set by the user may be notified each time the inquiry is received.

The communication abilities not contained in the notice from the user terminal 803 at Step S304 are not entered in the helper list created at Step S309.

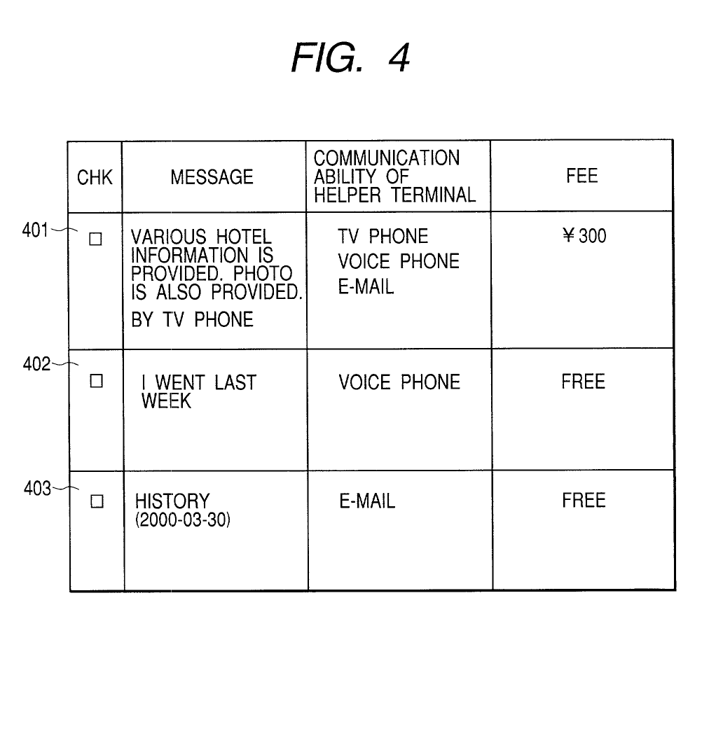

The helper list created in Step S309 does not contain information on the helper terminal 802 and information capable of identifying the helper in order to protect the privacy of the helper, although the list contains, for example, as shown in FIG. 4, information 401 of the helper terminal 802C HN0003, information of the helper terminal 802B HN0002, information 403 of the answer example database and the like.

In the case of a speech telephone, a program of the speech recognition/synthesis function 103a in FIG. 1 stored in the main storage device 103 of the help server 801 and the speech interface 106 in FIG. 1 synthesize the helper list (FIG. 4) into a speech and reproduce it to urge the user to select a desired helper terminal.

Information of the contents of the responses from the helper terminals 802 and the desired communication abilities and desired fees of the helper terminals 802 are stored in the answer/communication ability/fee field 1005 in FIG. 10 at a candidate helper number field in the corresponding inquiry field of the processing inquiry table 109 in FIG. 1.

At Step S311 the user selects the helper terminal having a most desired combination of the message, communication abilities and fee, from the helper list (FIG. 4) transmitted at Step S310, and requests a session from the user terminal 803 at Step S311. If a plurality of communication abilities are presented from the helper terminal, one (e.g., TV telephone) of them may be decided to request the helper terminal to use it. It is assumed in the following description that the user selects the helper terminal 802C.

Upon reception of the session request from the user terminal 803, the help server 801 judges whether the helper terminal 802C selected by the user is a pay information provider, by referring to the fee information 1005 in FIG. 10 stored in the processing inquiry table 109 in FIG. 1.

If the helper terminal 802C is the pay information provider, at Step S312 the help server 801 transmits a fee collection procedure request to the user terminal 803 to make the user terminal 803 perform the fee collection procedure at Step S313. For example, since the information fee of the helper terminal 802C HN0003 is 300 Yen, the user terminal 803 performs the fee collection procedure of 300 Yen.

Next, at Step S314 the help server 801 performs certification of the fee collection of the user terminal 803, and at Step S315 notifies the helper terminal 802C of the session request and fee pay notice of the user terminal 803. At this time, the communication ability (e.g., TV telephone) finally decided by the user is also notified.

If the helper terminal 802C returns a session response to the help server 801 at Step S316, the help server 801 transfers the session response to the user terminal 803 at Step S317.

In the session response transferred to the user terminal 803 at Step S317, the communication ability finally decided by the user is also notified. For example, if the user input the inquiry on the browser desires to receive an answer by a TV telephone and the helper terminal 802C and session are connected, a message such as “An income call will be received soon, please wait just a moment” is displayed on the browser. Alternatively, if the user inquired by a telephone desires to receive an answer by an e-mail and the helper terminal 802B and session are connected, a speech guidance such as “a mail was transmitted” is reproduced. The user listened to the speech guidance starts up a mailer to receive the answer (or the mailer of PC or PDA connected to the user terminal 803 is automatically starts up).

Next, at Step S318 the session between the user terminal 803 and helper terminal 802C starts by using the session management function 103e of the help server 801.

In the session at Step S318, data (in this example, data for the TV telephone) converted to match the communication ability is transferred between the user terminal 803 and helper terminal 802C via the help server 801, and the data is not transferred directly between the user terminal 803 and helper terminal 802C. With this arrangement of the help system of this embodiment, the anonymity of the user and helper can be guaranteed.

If the session request from the user terminal 803 at Step S311 does not contain the finally decided communication ability, the help server 801 refers to the processing inquiry table 109 in FIG. 1 and searches the coincident communication ability in the order from the higher priority order of communication abilities desired by the user terminal 803 and helper terminal 802C, to thereby automatically decide the communication ability to be applied to the session.

After the help server 801 confirms the normal start of the session at Step S318, the help server 801 performs the fee collection process for the user and fee payment process for the helper at Step S319, by using the fee payment/collection function 103d. These processes may be performed before or after the session at Step S318.

If the user desires to obtain more information after the start of the session at Step S318, then the help server 801 may perform an additional fee collection process for the user terminal 803 and an additional fee payment process for the helper terminal 802C at Step S319, by using the fee payment/collection function 103d.

For the fee collection process and fee payment process at Step S319, a portion of the fee may be paid to the help server 801 as a mediator commission.

An advertisement fee may be collected from an advertiser by transmitting an advertisement banner or message to the user terminal 803 or helper terminal 802C before or after the start of the session at Step S318.

If there is a helper (e.g., travel agent) whose object is the business activity, a registration fee may be collected from this helper.

The contents of the session started at Step S318 are stored in the answer example database 107 in FIG. 1. If a similar inquiry is issued thereafter, the answer example is searched at Step S307. However, the user terminal 803 or helper terminal 802 may reject storing the session contents in the answer example database 107 in FIG. 1, before or after the start of the session at Step S318 or after the end of the session.

If the session contents are stored in the answer example database 107 in FIG. 1, an additional fee may be paid to the helper terminal 802 as an information providing fee.

(Operation of Help Server)

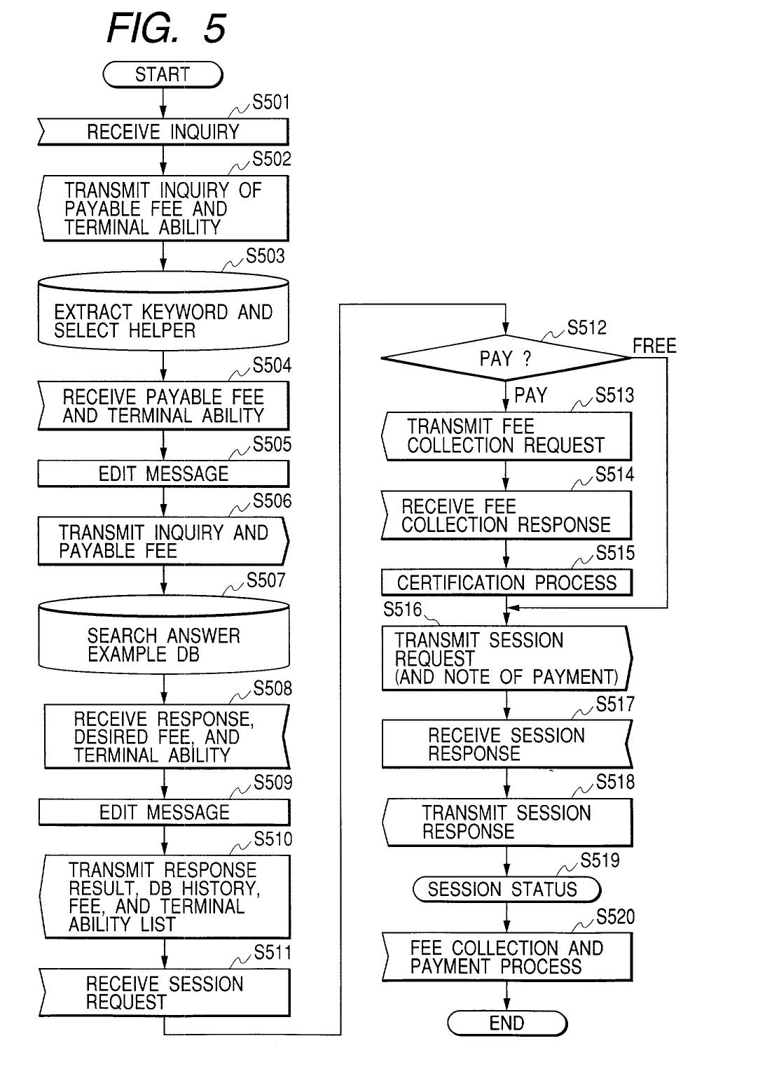

Next, with reference to the flow chart shown in FIG. 5, the operation of the help server 801 of the help system according to the embodiment will be described. A portion of the detailed description is the same as the description of the help system described earlier, so that this portion is omitted.

First, at Step S501 the help server 801 receives an inquiry from the user terminal 803.

The help server 801 received the inquiry from the user terminal 803 forms a new field in the processing inquiry table 109 in FIG. 1 and stores therein the user number 1001 in FIG. 10 and the inquiry contents 1003 in FIG. 10.

Next, at Step S502 the help server 801 transmits information on the payable fee (e.g., an approximate maximum fee payable to the information) and communication abilities of the user terminal 803 (data transfer speed, information transfer ability, terminal type and the like), to the user terminal 803.

In addition, at Step S503 the help server 801 extracts keywords from the inquiry contents of the user by using the keyword extraction function 103b in FIG. 1, and by referring to the helper management table (FIG. 2) stored in the helper database 108, searches the helper terminal 802 hitting the extracted keywords.

At Step S504, the help server 801 receives the notice of the payable fee and communication abilities from the user terminal 803. It is assumed herein that the notice order of the communication abilities is a higher priority order.

The help server 801 received the notice from the user terminal 803 stores the communication abilities of the user terminal 803 received at Step S504 in the user communication ability field 1002 in FIG. 10 in the corresponding inquiry field of the processing inquiry table 109 in FIG. 1.

Next, at Step S505 the help server 801 forms an inquiry message to be transmitted to the helper terminals 802, by using the massage editing/transmission function 103c, and then at Step S506 transmits the inquiry message to the helper terminals 802B and 802C searched at Step S503. The created message does not contain information on the user terminal 803 and information capable of identifying the user in order to protect the privacy of the user, although the message contains the information on the user inquiry contents, communication abilities of the user terminal 803 and the payable fee.

The helper number of each helper terminal 802 to which the message was transmitted at Step S506 is stored in the candidate helper number field 1004 in FIG. 10 in the corresponding inquiry field of the processing inquiry table 109 in FIG. 1.

At Step S507 the help server 801 searches the answer history of the past inquiry similar to the present inquiry from the answer example database 107 in FIG. 1, and stores it in the answer example number field 1004 in FIG. 10 in the corresponding inquiry field of the processing inquiry table 109 in FIG. 1.

At Step S508 the help server 801 receives responses to the message transmitted at Step S506 and messages of desired fees and desired communication abilities from the helper terminals 802. By referring to the contents of the messages from the helper terminals 802 and the past answer examples stored in the processing inquiry table 109 in FIG. 1, the help server 801 creates a helper list at Step S509 and transmits it to the user terminal 803 at Step S510. It is assumed that the higher priority order is used as the order of desired communication abilities of the helper terminals 802 contained in the helper list (FIG. 4) created at Step S509.

The helper list (FIG. 4) to be transmitted does not contain information on the helper terminal 802 and information capable of identifying the helper in order to protect the privacy of the helper.

After the user terminal 803 selects the desired helper terminal 802C from the helper list (FIG. 4), at Step S511 the help server 801 receives a session request from the user terminal 803.

At Step S512, the help server 801 judges whether the helper terminal 802C selected by the user is a pay information provider, by referring to the fee information 1005 in FIG. 10 stored in the processing inquiry table 109 in FIG. 1.

If the helper terminal 802C is the pay information provider, at Step S513 the help server 801 transmits a fee collection procedure request to the user terminal 803 to make the user terminal 803 perform the fee collection procedure at Step S514.

At Step S515 the help server 801 performs certification of the fee collection of the user terminal 803, and at Step S516 notifies the helper terminal 802C of the session request and fee pay notice of the user terminal 803.

At this time, the communication ability (e.g., TV telephone) finally decided by the user is also notified to the helper terminal 802C. If the session request from the user terminal 803 at Step S511 does not contain the finally decided communication ability, the help server 801 refers to the processing inquiry table 109 in FIG. 1 and searches the coincident communication ability in the order from the higher priority order of communication abilities desired by the user terminal 803 and helper terminal 802, to thereby automatically decide the communication ability to be applied to the session.

Upon reception of the session response from the helper terminal 802C at Step S517, the help server 801 transfers the session response to the user terminal 803 at Step S518. When the session response is transferred to the user terminal 803 at Step S518, the communication ability finally decided is also notified.

At Step S519 the help server 801 starts the session between the user terminal 803 and helper terminal 802C by using the session management function 103e.

In the session at Step S519, data (in this example, data for the TV telephone) converted to match the communication ability is transferred between the user terminal 803 and helper terminal 802C via the help server 801, and the data is not transferred directly between the user terminal 803 and helper terminal 802. With this arrangement of the help server 801 of this embodiment, the anonymity of the user and helper can be guaranteed.

After the help server 801 confirms the normal start of the session at Step S519, the help server 801 performs the fee collection process of the user and the fee payment process for the helper at Step S520, by using the fee payment/collection function 103d. These processes may be performed before or after the session at Step S519.

(Operation of User Terminal)

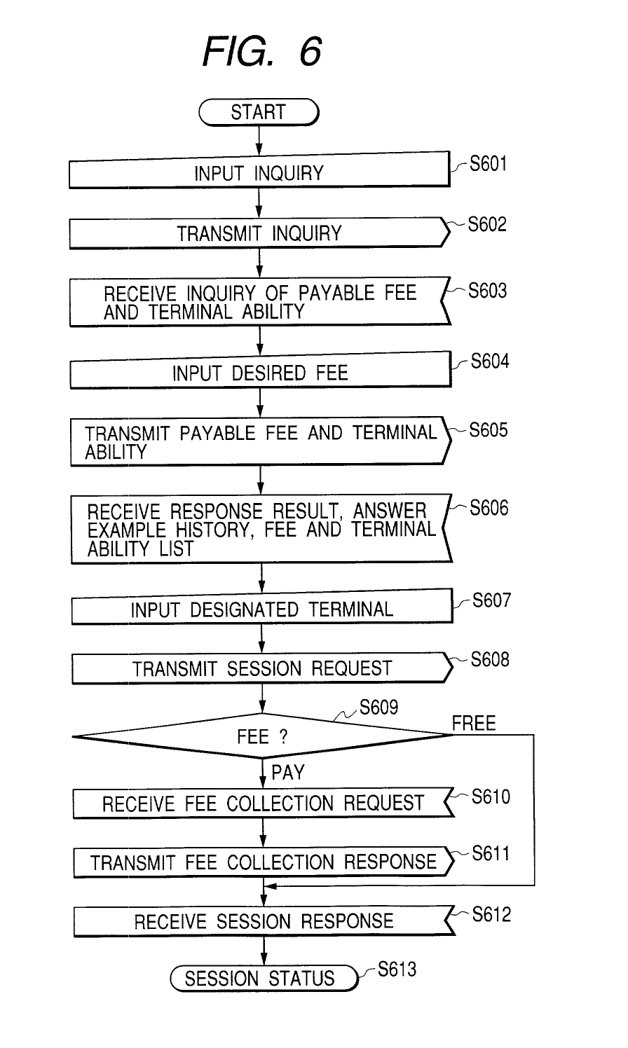

Next, with reference to the flow chart shown in FIG. 6, the operation of the user terminal 803 of the help system according to the embodiment will be described. A portion of the detailed description is the same as the description of the help system described earlier, so that this portion is omitted.

First, at Step S601 an inquiry is entered from the user terminal 803, and at Step S602 sent to the help server 801. As the inquiry methods from the user terminal 803 to the help server 801, a speech telephone, an e-mail, a message transmission on the Web via the network 804 and the like may be used.

When the user terminal receives at Step S603 an inquiry from the help server 801 as to a payable fee (e.g., an approximate maximum fee payable to the information) and communication abilities of the user terminal 803 (data transfer speed, information transfer ability, terminal type and the like), the user enters a desired fee for the inquiry and the like at Step S604 and transmits them to the help server 801 at Step S605. The higher priority order is preferably used as the order of communication abilities of the user terminal 803. A communication ability order preset at the user terminal 803 may be notified, or a communication ability order desired to be used by the user for the response to the inquiry and manually set by the user may be notified.

At Step S606 the user terminal 803 receives the helper list (FIG. 4) from the help server 801. At Step S607 the user selects the desired helper terminal 802C from the helper list (FIG. 4) and enters the selected helper terminal in the user terminal 803. At Step S608 the user terminal 803 transmits a session request to the help server 801.

If the helper terminal 802C selected by the user at Step S607 is a pay information provider, the user terminal 803 receives a fee collection procedure request from the help server 801 at Step S610, and performs the fee collection procedure at Step S611.

After the user terminal 803 receives a session response from the help server 801 at Step S612, the user terminal 803 starts the session with the helper terminal 802C via the help server 801 at Step S613.

(Operation of Helper Terminal)

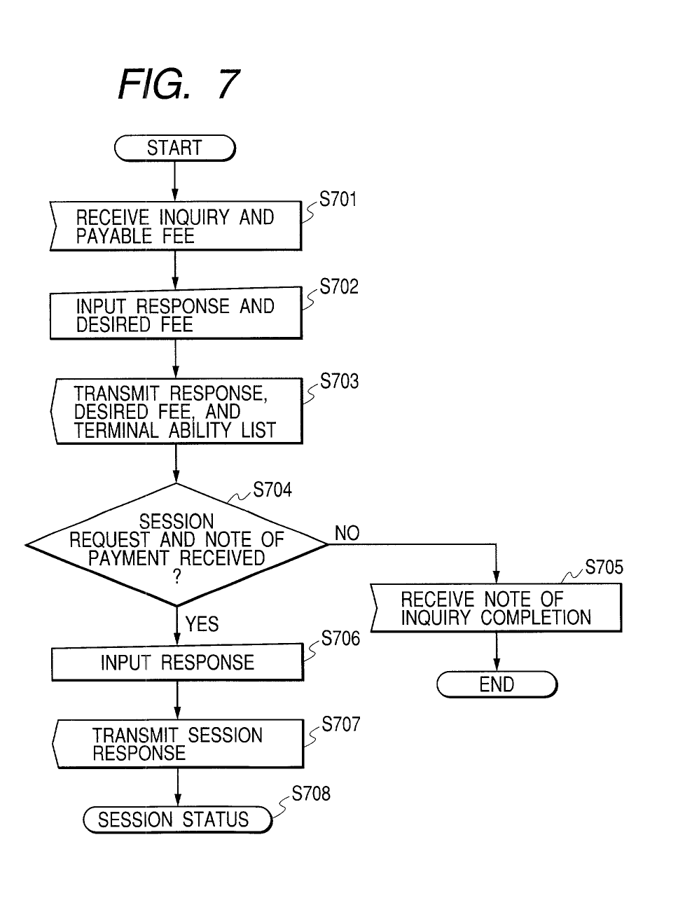

Lastly, with reference to the flow chart shown in FIG. 7, the operation of the helper terminal 802 of the help system according to the embodiment will be described. A portion of the detailed description is the same as the description of the help system described earlier, so that this portion is omitted.

First, at Step S701 the helper terminal 802 receives an inquiry message from the help server 801. The inquiry message does not contain information on the user terminal 803 and information capable of identifying the user in order to protect the privacy of the user, although the inquiry message contains the information on the user inquiry contents, communication abilities of the user terminal 803 and the payable fee.

The method of receiving the message at Step S701 may be group reception or group mailing, or if the helper terminal 802 is a wireless terminal or the like, the message entered in the extended data field of group notice information may be received.

The method of receiving the message at Step S701 may be designated and registered beforehand in the helper management table (FIG. 2) for each helper terminal 802.

If the helper can answer the inquiry received at Step S701, at Step S702 the helper enters a response message, desired fee, desired communication ability and the like in the helper terminal 802, and at Step S703 transmits them to the help server 801. The higher priority order is also preferably used as the order of desired communication abilities of the helper terminal 802. A communication ability order preset by the helper for the response to the inquiry and desired to be used by the helper may be notified, or a communication ability order manually set by the helper may be notified each time the inquiry is received. A communication order not relevant to the inquiry may also be notified.

At Step S704 the helper terminal 802 selected by the user receives from the help server 801 the session request of the user terminal 803, fee payment notice and communication ability (e.g., TV telephone) finally decided by the user.

At Step S705 the helper terminals 802 not selected by the user and not received the session request receives an inquiry completion notice from the help server 801. This reception of the inquiry completion notice may be omitted.

Upon reception of the session request of the user terminal 803 and the fee payment notice from the help server 801, the helper terminal 802 confirms the fee information and the like, and thereafter enters a session response at Step S706 to transmit it to the help server 801 at Step S707.

At Step S708 the helper terminal 802 starts the session with the user terminal 803 via the help server 801.

Although the embodiment describes specific examples for the purposes of convenience, the invention is not limited only to the above-described embodiment. For example, a desired information processing apparatus may be used as the user terminal or helper terminal, and a desired communication method may be used as the communication method for network connection.

(Other Embodiments of the Invention)

The invention is also applicable to a system having a plurality of apparatuses (e.g., a host computer, an interface apparatus, a reader, a printer and the like) or to a single apparatus.

The scope of the invention contains also the case wherein software program codes realizing the function of each embodiment described above are supplied to a computer (CPU or MPU) of the apparatus or system connected to various devices realizing the embodiment function, and the computer operates the devices in accordance with the stored programs.

In this case, the software program codes themselves realize the embodiment function. Therefore, the program codes themselves and means for supplying the program codes, e.g., a storage medium storing the program codes, constitute the present invention. The storage medium for storing such program codes may be a floppy disk, a hard disk, an optical disk, a magneto optical disk, a CD-ROM, a magnetic tape, a nonvolatile memory card, a ROM or the like.

It is obvious that the program codes are included in the embodiment of the invention, wherein not only the computer executes the supplied program codes to realize the embodiment function but also the program codes in cooperation with an OS (operating system) running on the computer or with another application or the like realize the embodiment function.

It is obvious that the scope of the invention also contains the case wherein the functions of each embodiment can be realized by writing the program codes into a memory of a function expansion board inserted into a computer or of a function expansion unit connected to the computer, and thereafter by executing a portion or the whole of actual processes by a CPU of the function expansion board or function expansion unit.

What is claimed is:

1. A server capable of communication with a user terminal and a helper terminal for providing information to the user terminal, comprising:
storage means for storing helper information of the helper terminal;
reception means for receiving from the user terminal an inquiry about information desired by a user; and
selection means for selecting the helper terminal in accordance with the inquiry received by said reception means and the helper information stored in said storage means.

2. A server according to claim 1, wherein the helper information stored in said storage means is keywords of the information which the helper terminal can provide.

3. A server according to claim 1, wherein:
said reception means receives at least one of a communication ability of the user terminal and a desired fee for obtaining the information desired by the user; and
the server further comprises transmission means for transmitting the inquiry received by said reception means to the helper terminal selected by said selection means.

4. A server according to claim 1, further comprising:
notice means for notifying the helper terminals selected by said selection means to the user terminal; and
connection means for establishing a communication between the user terminal and the helper terminal selected by the user from the helper terminal notified by said notice means.

5. A server according to claim 4, wherein said notice means notifies at least one of a communication ability and a desired fee of the helper terminal selected by said selection means.

6. A server according to claim 4, further comprising:
second storage means for storing information provided by the helper terminal;
wherein said notice means notifies the information stored in said second storage means.

7. A server according to claim 6, wherein at least a permission for storing the information in said second storage means is required to be received from the helper terminal or a permission for notifying by said notice means is required to be received from the user terminal.

8. A server according to claim 1, further comprising payment requesting means for requesting the user terminal to pay a fee for the obtained information.

9. A server according to claim 1, further comprising payment processing means for paying a fee for the information provided by the helper terminal.

10. A server according to claim 1, further comprising fee collecting means for collecting a registration fee for storing the helper information in said storage means.

11. A server according to claim 1, further comprising advertisement distributing means for distributing advertisement information to at least one of the user terminal and the helper terminal.

12. A server according to claim 1, further comprising extraction means for extracting keywords from the inquiry received by said reception means, wherein said selection means selects the helper terminal in accordance with the keywords extracted by said extraction means.

13. A control method of controlling a system having a server capable of communication with a user terminal and a helper terminal for providing information to the user terminal, comprising:
a storage step of storing helper information of the helper terminal;
a reception step of receiving from the user terminal an inquiry about information desired by a user; and
a selection step of selecting the helper terminal in accordance with the inquiry received at said reception step and the helper information stored by said storage step.

14. A control method of controlling a system having a server capable of communication with a user terminal and a plurality of helper terminals for providing information to the user terminal, comprising:
a storage step of storing helper information of the plurality of helper terminals;
a reception step of receiving from the user terminal an inquiry about information desired by a user; and
a selection step of selecting helper terminals in accordance with the inquiry received at said reception step and the helper information stored by said storage step.

15. A storage medium storing a computer readable program for realizing a control method of controlling a system having a server capable of communication with a user terminal and a helper terminal for providing information to the user terminal, the program comprising:
a storage step of storing helper information of the helper terminal;
a reception step of receiving from the user terminal an inquiry about information desired by a user; and
a selection step of selecting the helper terminal in accordance with the inquiry received at said reception step and the helper information stored by said storage step.

16. A storage medium storing a computer readable program for realizing a control method of controlling a system having a server capable of communication with a user terminal and a plurality of helper terminals for providing information to the user terminal, the program comprising:
a storage step of storing helper information of the plurality of helper terminals;
a reception step of receiving from the user terminal an inquiry about information desired by a user; and
a selection step of selecting helper terminals in accordance with the inquiry received at said reception step and the helper information stored by said storage step.
